(19) United States
(12) Patent Application Publication
(10) Pub. No.: US 2009/0070761 A1
(43) Pub. Date: Mar. 12, 2009

(54) System and method for data communication with data link backup

(75) Inventor: Yu Zhao, Wuhan (CN)

Correspondence Address: PATENT PROSECUTION;O2MIRCO , INC., 3118 PATRICK HENRY DRIVE, SANTA CLARA, CA, 95054, US

(73) Assignee: O2Micro Inc.

(21) Appl. No.: 11/899,499

(22) Filed: Sep. 6, 2007

(51) Int. Cl. G06F 9/455; G06F 15/16

(52) U.S. Cl. 718/1; 709/231

(57) ABSTRACT

According to one embodiment of the invention, there is provided a data communication device for processing a data stream, including a runtime virtual machine (VM) and a mirror VM. The two VMs are independently running on the same physical hardware of the data communication device. The runtime VM is operable for receiving the data stream and establishing a plurality of data links to process the data stream. The mirror VM is operable for backing up the data links established by the runtime VM. The data stream is switched from the runtime VM to the mirror VM for processing if a predetermined condition occurs in the runtime VM.

### FIELD OF THE INVENTION

The invention relates to a data communication device, and more particularly, to a data communication device with data link backup utilizing virtualization technology.

### BACKGROUND OF THE INVENTION

In a computer network, a data communication device such as a firewall/virtual private network (VPN) device usually receives a data stream through an input port, processes the data stream according to predetermined rules, and sends out the processed data stream to a plurality of users. During this process, a plurality of data links are established and managed by the firewall/VPN devices. Generally, an additional hardware backup device is used to backup the data links to achieve high availability (which is a system design protocol and associated implementation that ensures a certain absolute degree of operational continuity during a given measurement period) of such devices. Once a failure occurs, the backup device immediately starts to operate based on the backup data links for continuous processing of the data stream, so that the data communication is not interrupted.

FIG. 1 illustrates a traditional method to backup firewall/VPN data links by utilizing two separate hardware devices including an operating firewall/VPN device 102 and a backup firewall/VPN device 104. Each of the operating firewall/VPN device 102 and the backup firewall/VPN device 104 may have an operating system 108 running on a separate physical hardware 106, and an application software 110 for processing a input data stream, for managing a plurality of data links, and for providing a processed data stream. Usually, it is the firewall/VPN device 102 that processes the input data stream and manages data links. When a failure occurs with the operating firewall/VPN device 102, a link switch is performed manually or automatically according to a predetermined mechanism, such that the input data stream is switched to the backup firewall/VPN device 104. As such, the backup firewall/VPN device 104 is used to process the input data stream and manage the data links.

For such kind of firewall/VPN devices, some problems are caused by software problems, such as kernel panic or full CPU occupancy, rather than hardware problems. However, users still have to buy another hardware backup device for emergency replacement to ensure the availability and reliability when the operating device is crashed or becomes unavailable. In addition, there is usually some redundant or wasted hardware capability that is not fully utilized.

### SUMMARY OF THE INVENTION

According to one embodiment of the invention, there is provided a data communication device for processing a data stream, including a runtime virtual machine (VM) and a mirror VM. The two VMs are independently running on the same physical hardware of the data communication device. The runtime VM is operable for receiving the data stream and establishing a plurality of data links to process the data stream. The mirror VM is operable for backing up the data links established by the runtime VM. The data stream is switched from the runtime VM to the mirror VM for processing if a predetermined condition occurs in the runtime VM.

### BRIEF DESCRIPTION OF THE DRAWINGS

Features and advantages of embodiments of the invention will become apparent as the following detailed description proceeds, and upon reference to the drawings, where like numerals depict like elements, and in which:

FIG. 1 illustrates a traditional method to backup firewall/VPN data links by utilizing two separate hardware devices.

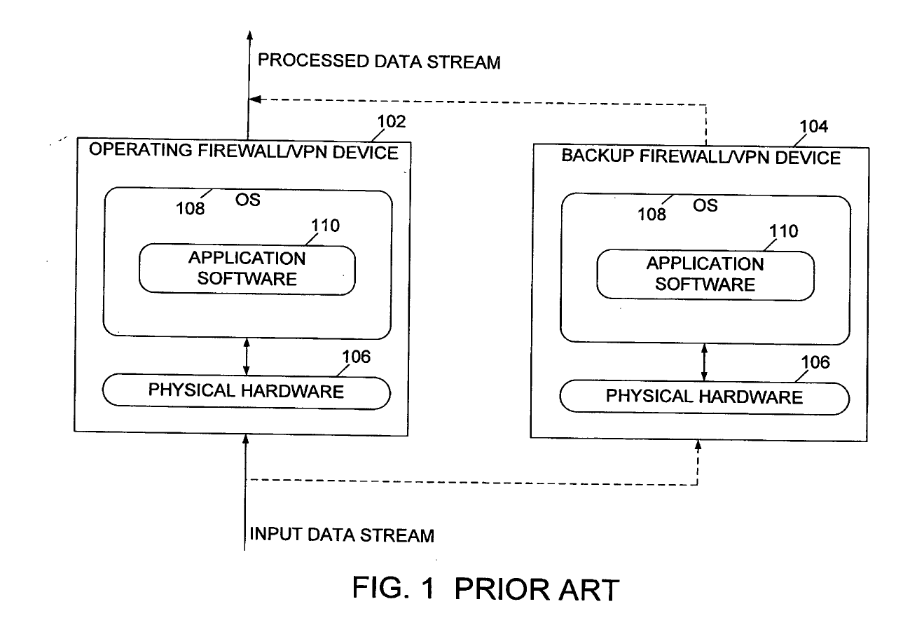

FIG. 2 illustrates an exemplary architecture of a data communication device using two virtual machines, in accordance with one embodiment of the present invention.

FIG. 3 illustrates an exemplary architecture of a data communication device based on another kind of virtual machine system, in accordance with one embodiment of the present invention.

FIG. 4 illustrates an exemplary flow chart of operations performed by a data communication device, in accordance with one embodiment of the present invention.

### DETAILED DESCRIPTION OF THE INVENTION

In one embodiment, the present invention provides a data communication device which performs seamless link switch by utilizing virtual machines. The data communication system can simultaneously operate one or more virtual machines on a single real or physical hardware. A virtual machine can be a logical entity that is implemented over a hardware platform. Advantageously, in such data communication device, each virtual machine can run a copy of operating system independently of the other virtual machine, and yet utilize the same hardware resources. Thereby, flexible and secure consolidation of multiple operating systems and applications onto a single platform can be enabled. Advantageously, hardware backup device is not necessary, in one embodiment.

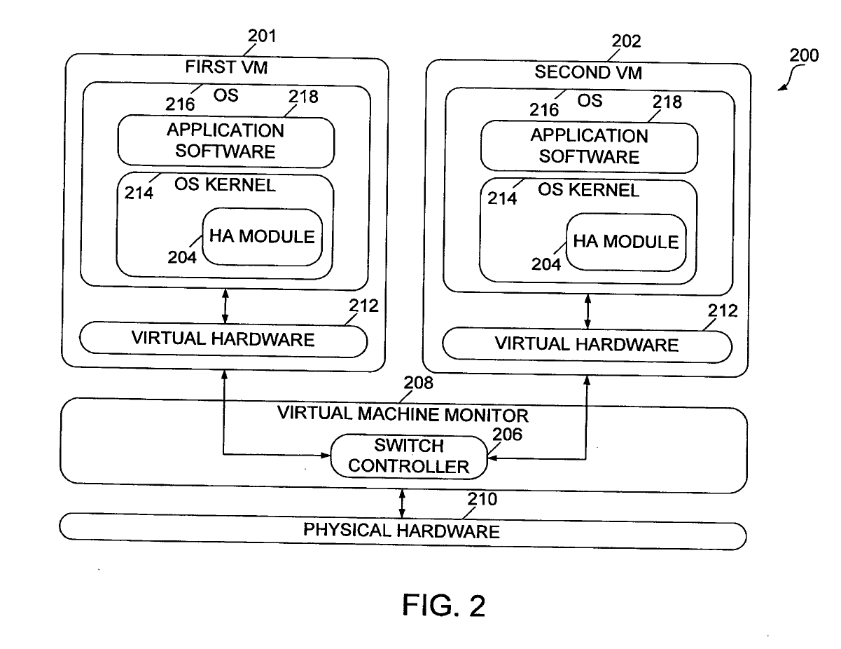

FIG. 2 illustrates an exemplary architecture of a data communication device 200 using two virtual machines, in accordance with one embodiment of the present invention.

The data communication device 200 includes a physical hardware 210, a virtual machine monitor (hypervisor) 208, a first virtual machine (VM) 201, and a second VM 202, in one embodiment. In one embodiment, either one of these two VMs is processing an input data stream at a time, which is defined as a runtime VM. The other VM can be defined as a mirror VM. Both the runtime VM and the mirror VM are running on the same physical hardware 210, which means that both runtime VM and mirror VM utilize the hardware resources of the physical hardware 210 to perform certain tasks.

In one embodiment, the data communication device 200 can be a firewall/virtual private network (VPN) device. In one embodiment, the runtime VM can be an operating firewall/VPN device, while the mirror VM can be regarded as a backup firewall/VPN device.

In one embodiment, the runtime VM is running on a physical hardware device 210 and is operable for receiving a data stream and for establishing a plurality of data links to process the data stream. In one embodiment, the mirror VM is running on the physical hardware device 210 and is operable for backing up the plurality of data links established by the runtime VM. Advantageously, the data stream can be switched from the runtime VM to the mirror VM for processing if a predetermined condition occurs in the runtime VM.

Advantageously, the mirror VM can back up the plurality of data links established by the runtime VM in a real time fashion. In one embodiment, if a predetermined condition occurs in the runtime VM, the mirror VM can immediately operate according to the backup data links for continuously processing the data stream.

In one embodiment, the predetermined condition may include, but is not limited to, an error of the runtime VM, a failure of the runtime VM, and an absence of the runtime VM. The physical hardware 210 may include hardware such as central processing units (CPUs), storage units, networking hardware, input/output hardware, and any other appropriate hardware.

A virtual machine monitor (VMM) 208 can be running on the physical hardware 210. The virtual machine monitor 208 in communication with runtime VM and mirror VM (the first VM 201 and the second VM 202) can monitor both runtime VM and mirror VM. For example, a failure of the runtime VM can be detected by the virtual machine monitor 208. The virtual machine monitor 208 switches the data stream from the runtime VM to the mirror VM for processing if the predetermined condition occurs in the runtime VM, in one embodiment.

Each of the runtime VM and the mirror VM (the first VM 201 and the second VM 202) includes a virtual hardware 212 and an operation system (OS) 216 running on the virtual hardware 212, in one embodiment. The operating system 216, which includes an OS kernel 214, can access and operate the virtual hardware 212, and run a plurality of application software 218 to manage a plurality of data links. The virtual hardware 212 may include a set of virtualized hardware which is the same as the physical hardware 210, or may include a set of virtualized hardware which is different from the physical hardware 210, in one embodiment.

Furthermore, each of the runtime VM and the mirror VM (the first VM 201 and the second VM 202) can comprise a high availability module (HA module, e.g., a module that has a certain degree of operational continuity during a given measurement period) 204 which can be located within the OS kernel 214. Each HA module 204 is in communication with the virtual machine monitor 208, in one embodiment. In one embodiment, the HA module 204 of the mirror VM is able to acquiring information from the runtime VM via the virtual machine monitor 208 and informing the virtual machine monitor 208 about a status of the runtime VM.

More specifically, the mirror VM can monitor the runtime VM to detect the availability of the runtime VM. When there is a predetermined condition occurs in the runtime VM, for example, when there is a failure occurs in the runtime VM, the HA module 204 of the mirror VM is able to informing the virtual machine monitor 208 about such failure. As a result, the virtual machine monitor 208 can detect the failure of the runtime VM and switch the data stream from the runtime VM to the mirror VM for processing.

Advantageously, in one embodiment, through the virtual machine monitor 208, the HA module 204 of the mirror VM is capable of receiving state information of the plurality of data links established by the runtime VM, and backing up the plurality of data links. In one embodiment, the state information of the plurality of data links may include, but is not limited to, routing information, session information, and log information. Consequently, the mirror VM can immediately operate according to the backup data links for continuously processing the data stream, in one embodiment.

In one embodiment, a switch controller 206 can be embedded in the virtual machine monitor 208, for performing link switch. The switch controller 206 can switch the data stream from the runtime VM to the mirror VM, if a predetermined condition (e.g., a failure) occurs in the runtime VM. More specifically, the switch controller 206 is capable of forwarding the data stream to the mirror VM and stopping forwarding the data stream to the runtime VM, if a predetermined condition occurs in the runtime VM. In one embodiment, the switch controller 206 can have numerous configurations. For example, the switch controller 206 can comprise a link switch arbitration module (not shown) used to interact with the HA module 204 of the runtime VM and the mirror VM, an alternative execution module (not shown) used to control the flow direction of the data stream, and a configuration module (not shown) used to configure the switch condition and manage the behavior of the link switch arbitration module.

In operation, the data communication device 200 receives a data stream from a network or another device through an I/O port (not shown in FIG. 2) of the physical hardware 210. The switch controller 206 forwards the data stream to the first VM 201, in which the data stream is processed by the application software 218 which can be running inside the OS 216. In one embodiment, the data stream is processed by the first VM 201 according to a plurality of predetermined rules. As such, a plurality of data links can be established in the first VM 201 according to the plurality of predetermined rules. At this moment, the first VM 201 can be regarded as an operating VM (e.g., an operating firewall/VPN device), while the second VM 202 can be regarded as a backup VM (e.g., a backup firewall/VPN device). The HA module 204 of the second VM 202 is able to acquiring state information of the data links established in the first VM 201, such as routing information, session information and log information of the data links, and backing up the data links established in the first VM 201 in a real time fashion. Under this circumstance, the first VM 201 is a runtime VM and the second VM 202 is a mirror VM, in one embodiment. Meanwhile, the runtime VM (first VM 201) can be monitored by either the virtual machine monitor 208 or the HA module 204 of the mirror VM (second VM 202), or by both.

In one embodiment, the runtime VM (first VM 201) can be monitored by the virtual machine monitor 208. The virtual machine monitor 208 can switch the data stream from the runtime VM (first VM 201) to the mirror VM (second VM 202) for processing when a predetermined condition occurs in the runtime VM (first VM 201). Specifically, in one embodiment, the link switch arbitration module (not shown) in the virtual machine monitor 208 can monitor system information such as CPU occupancy, memory usage state, etc. When a predetermined condition occurs in the runtime VM (first VM 201), the link switch arbitration module (not shown) can instruct the alternative execution module (not shown) to switch the data stream from the runtime VM (first VM 201) to the mirror VM (second VM 202) for processing. In such circumstance, the data communication device 200 is running in a native link recovery mode, in which the data stream switch is triggered by the virtual machine monitor 208.

In one embodiment, the runtime VM (first VM 201) can also be monitored by the HA module 204 of the mirror VM (second VM 202). The HA module 204 of the mirror VM (second VM 202) can inform the virtual machine monitor 208 to switch the data stream from the runtime VM (first VM 201) to the mirror VM (second VM 202) for processing when a predetermined condition occurs in the runtime VM (first VM 201). Specifically, when a predetermined condition occurs in the runtime VM (first VM 201), the HA module 204 of the mirror VM (second VM 202) can inform the link switch arbitration module (not shown) to instruct the alternative execution module (not shown) to switch the data stream from the runtime VM (first VM 201) to the mirror VM (second VM 202) for processing. In such circumstance, the data communication device 200 is running in a passive link recovery mode, in which the data stream switch is triggered by the HA module 204 of the mirror VM (second VM 202).

In one embodiment, there are various methods to monitor the availability of the runtime VM (first VM 201). One of these methods is to use heart-beat probing mechanism, in one embodiment. In a heart-beat probing method, the runtime VM (first VM 201) can generate heart-beat signals at a predetermined frequency. If the virtual machine monitor 208 and/or the mirror VM (second VM 202) can detect the heart-beat signals at the predetermined frequency, the runtime VM (first VM 201) is regarded in normal operation, in one embodiment.

In one embodiment, if heart-beat signals can not be detected, the runtime VM (first VM 201) is regarded encountering a failure/error (a predetermined condition). For instance, the runtime VM (first VM 201) may be crashed or unavailable, or there may be a software dead loop. The switch controller 206 can perform a link switch by stopping forwarding the data stream to the runtime VM (first VM 201), and forwarding the data stream to the mirror VM (second VM 202). Then the second VM 202 starts to process the data stream according to the backup data links for continuously managing the data links, which can be monitored by the first VM 201 and/or the virtual machine monitor 208. In one embodiment, the first VM 201 is forced to reboot by the virtual machine monitor 208 if necessary, for re-enabling the first VM 201. As a result, the first VM 201 and the second VM 202 exchanges their roles, such that the first VM 201 becomes the mirror VM and the second VM 202 becomes the runtime VM.

Advantageously, since the mirror VM has backup copies of the state information of the data links established in the runtime VM, the mirror VM can be able to immediately continue processing the data stream, in one embodiment. Consequently, the data links can be transferred from the runtime VM to the mirror VM seamlessly, and users can hardly notice there is a link switch performed, in one embodiment.

Besides the virtual machine system adopted to implement the data communication device 200 of FIG. 2, other virtual machine systems can also be utilized. With similar mechanism, the invention disclosed in this application can be implemented based on different virtual machine systems.

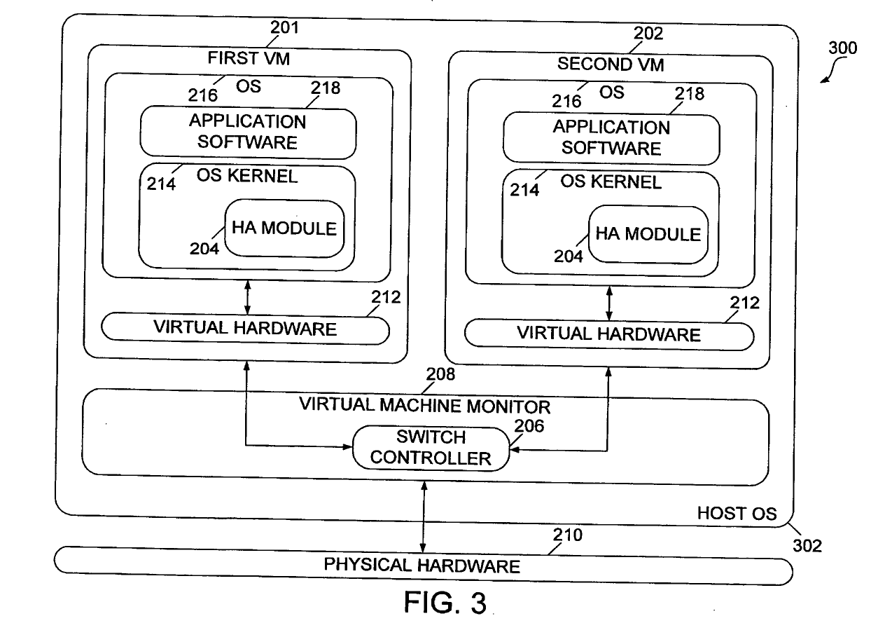

For example, FIG. 3 illustrates an exemplary architecture of a data communication device 300 based on another virtual machine system. Elements that are labeled the same as in FIG. 2 have similar functions and will not be repetitively described herein for purposes of brevity and clarity.

The data communication device 300 in FIG. 3 further includes a host operating system (host OS) 302 running on the data communication device 300. The virtual machine monitor 208, the first VM 201 and the second VM 202 can run inside the host OS 302.

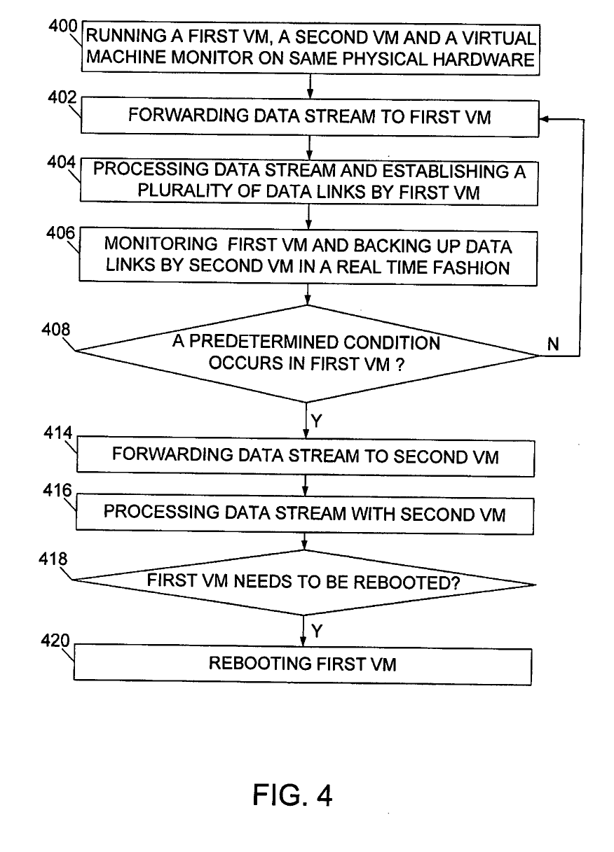

FIG. 4 illustrates an exemplary flow chart of operations performed by a data communication device, in accordance with one embodiment of the present invention. In the beginning, a first VM, a second VM and a virtual machine monitor can be running on the same physical hardware of the data communication device, block 400. A data stream received by the data communication device can be forwarded to the first VM, block 402. The first VM can process the data stream and establish a plurality of data links, block 404. The first VM can be monitored by the virtual machine monitor and/or the second VM, and the data links which are established in the first VM can be backed up by the second VM in a real time fashion, block 406.

If a predetermined condition (e.g., a failure) occurs in the first VM, block 408, the data stream is switched from the first VM to the second VM through the following steps. The data stream is forwarded to the second VM, block 414. And then the second VM starts to process the data stream, block 416. If no predetermined condition (e.g., a failure) occurs in the first VM, the flowchart returns to block 402. Steps following 402 have been described above and will be omitted herein for purposes of brevity and clarity.

Afterwards, the virtual machine monitor can check the status of the first VM to determine whether the first VM needs to be rebooted, block 418. If yes, the first VM will be rebooted, step 420. Otherwise, the first VM will not be rebooted.

Therefore, here is provided a data communication device for data link backup. Two virtual machines (VM) including a runtime virtual machine and a mirror VM are independently running on the same physical hardware of the data communication device. The runtime VM is operable for receiving the data stream and establishing a plurality of data links to process the data stream. The mirror VM is operable for backing up the data links established by the runtime VM. Advantageously, the data stream can be switched seamlessly from the runtime VM to the mirror VM for processing if a predetermined condition occurs in the runtime VM. Advantageously, the mirror VM can immediately operate according to the backup data links for continuously processing the data stream. According to the present invention, hardware backup device which is used in traditional method to backup data links is not necessary.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A data communication device comprising:
a runtime virtual machine (VM) running on a physical hardware device and operable for receiving a data stream and for establishing a plurality of data links to process said data stream; and
a mirror VM running on said physical hardware device and operable for backing up said plurality of data links,
wherein said data stream is switched from said runtime VM to said mirror VM for processing if a predetermined condition occurs in said runtime VM.

2. The data communication device of claim 1, wherein said mirror VM backs up said plurality of data links in a real time fashion.

3. The data communication device of claim 1, wherein said mirror VM operates according to said plurality of data links for continuously processing said data stream, if said predetermined condition occurs in said runtime VM.

4. The data communication device of claim 1, further comprising:
a virtual machine monitor operable for monitoring said runtime VM and said mirror VM.

5. The data communication device of claim 1, wherein said predetermined condition comprises an error.

6. The data communication device of claim 1, wherein each of said runtime VM and said mirror VM comprises a high availability module, and wherein said high availability module of said mirror VM is capable of acquiring information from said runtime VM.

7. The data communication device of claim 1, further comprising:
a switch controller being capable of switching said data stream from said runtime VM to said mirror VM, if said predetermined condition occurs in said runtime VM.

8. The data communication device of claim 1, further comprising:
a host operating system (host OS) running on said data communication device, wherein said runtime VM and said mirror VM are running inside said host operating system.

9. The data communication device of claim 1, wherein said data communication device comprises a firewall/VPN device.

10. A method for data communication, comprising:
processing a data stream by a first virtual machine (VM);
establishing a plurality of data links by said first VM;
backing up said plurality of data links by a second VM; and
switching said data stream from said first VM to said second VM if a predetermined condition occurs in said first VM.

11. The method of claim 10, further comprising:
processing said data stream by said second VM.

12. The method of claim 10, further comprising:
monitoring said first and second VMs.

13. The method of claim 10, further comprising:
monitoring said first VM by said second VM.

14. The method of claim 10, further comprising:
rebooting said first VM if said predetermined condition occurs in said first VM.

15. The method of claim 10, further comprising:
running a host operating system on said data processing device,
wherein said first VM and said second VM are running inside said host operating system.

16. A data communication device comprising:
a runtime virtual machine (VM) running on a physical hardware device and operable for receiving a data stream and for establishing a plurality of data links to process said data stream;
a mirror VM running on said physical hardware device and operable for backing up said plurality of data links; and
a virtual machine monitor in communication with said runtime VM and said mirror VM, and operable for monitoring said runtime VM and for switching said data stream from said runtime VM to said mirror VM for processing if a predetermined condition occurs in said runtime VM.

17. The data communication device of claim 16, wherein said predetermined condition comprises an error.

18. The data communication device of claim 16, wherein each of said runtime VM and said mirror VM comprises a high availability module which is in communication with said virtual machine monitor, and wherein said high availability module of said mirror VM is capable of acquiring information from said runtime VM and informing said virtual machine monitor about a status of said runtime VM.

19. The data communication device of claim 16, wherein said virtual machine monitor further comprises a switch controller being capable of forwarding said data stream to said mirror VM and stopping forwarding said data stream to said runtime VM, if a predetermined condition occurs in said runtime VM.

20. The data communication device of claim 16, further comprising:
a host operating system (host OS) running on said data communication device, wherein said virtual machine monitor, said runtime VM, and said mirror VM are running inside said host operating system.

21. The data communication device of claim 16, wherein said data communication device comprises a firewall/VPN device.

22. The data communication device of claim 16, wherein said mirror VM backs up said plurality of data links in a real time fashion.
